(19) United States
(12) Patent Application Publication
(10) Pub. No.: US 2003/0135399 A1
(43) Pub. Date: Jul. 17, 2003

(54) System and method for project optimization

(76) Inventors: Soori Ahamparam, Millburn, NJ (US); Sandra Deming, Brooklyn, NY (US); Timothy Brian Murphy, Surrey (GB); Cynthia Elizabeth, Forest Hills, NY (US); Barry Sheehy, Savannah, GA (US); Brenda Schone, Wilton, CT (US)

Correspondence Address: SNELL & WILMER, ONE ARIZONA CENTER, 400 EAST VAN BUREN, PHOENIX, AZ, 850040001

(21) Appl. No.: 10/118,528

(22) Filed: Apr. 5, 2002

Related U.S. Application Data
(60) Provisional application No. 60/349,119, filed on Jan. 16, 2002.

(51) Int. Cl. G06F 17/60

(52) U.S. Cl. 705/7

(57) ABSTRACT

A system and method for project optimization, including methodologies, processes, measures, and tools for facilitating the management processes throughout the life-cycle of the project, including conception, planning, execution, and post-implementation review. Various embodiments include a project management system comprised of four separate processing steps including portfolio management, value planning, customized project management, and post-implementation review. Other embodiments include an integrated governance paradigm configured to globally manage the four processing steps described above.

### REFERENCE TO RELATED DOCUMENTS

This application claims priority to, and the benefit of, U.S. Provisional Patent Application Serial No. 60/349119, entitled INTEGRATED VALUE SYSTEM AND METHOD filed on Jan. 16, 2002, the contents of which is hereby incorporated by reference.

### FIELD OF INVENTION

The present invention relates to a system and method for project optimization, including methodologies, processes, measures, and tools for facilitating the management of the project throughout the project life-cycle, including conception, planning, execution, and post-implementation review.

### BACKGROUND OF THE INVENTION

Technological projects are fast becoming possibly the largest single capital expenditure for corporate operating budgets today. In particular, United States corporations are outspending the rest of the developed world on technological projects by a wide margin. This represents a large gamble on the future that, so far, has typically paid off in terms of higher productivity and accelerated growth. However, many of these projects fail to deliver the financial value or financial results expected. By some estimates, a staggering 50% of these projects come in late, over budget, under-perform, or under-deliver on promised value. In the United States, it is estimated that these project failures are costing corporations in excess of $100 billion annually and may be the single greatest source of lost shareholder value in the economy.

Technology itself is sometimes considered to be the root of the problem as it is often poorly understood, hard to define, and constantly changing. However, others consider technology to account for only 15% of project failures. The remaining problems may include a lack of marketing vision, improper management structures, and the lack of global project governance, from conception to implementation.

Technology intensive projects typically require a great deal of resources and managerial oversight. Yet most are not allocated adequate staffing and resources to properly oversee the project. End-to-end governance perspectives are also minimal or non-existent, especially in the early planning or execution stages of the projects. The right questions are often not being asked concerning value, execution capabilities, and risk. Moreover, vertical governance is often fragmented and poorly defined. However, solutions to these problems may allow a project stakeholder tremendous competitive advantages in the marketplace. Accordingly, a need exists for a system including various methodologies, processes, measures, and tools to facilitate and promote project optimization from conception through execution.

### SUMMARY OF THE INVENTION

The present invention overcomes the deficiencies of the prior art by providing methodologies, processes, measures and tools for facilitating and promoting project optimization from conception through execution. The system includes planning and achieving value throughout the life cycle of the project. The system also facilitates obtaining maximum value from a project regardless of where a company is in the project life cycle. The invention includes systems and methods for increasing the value that is received from top-tier projects and reducing the waste and re-work. The invention facilitates the delivery of promised returns as outlined in the business cases of projects when they are started. As such, the invention helps to improve overall project performance as well as drive projects to market faster with fewer errors.

In accordance with an exemplary embodiment of the present invention, a system and method is provided comprising various subsystems, including: (i) portfolio management; (ii) value planning; (iii) customized project management; and (iv) post-implementation review. In accordance with these various subsystems, greater value and project efficiencies can be achieved. The various subsystems may be managed through another aspect of the invention, integrated governance, allowing greater efficiencies of the overall process through holistic governing paradigms.

### BRIEF DESCRIPTION OF THE DRAWINGS

Additional aspects of the present invention will become evident upon reviewing the non-limiting embodiments described in the specification and the claims taken in conjunction with the accompanying figures, wherein like reference numerals denote like elements.

FIG. 1 is an exemplary block diagram illustrating various exemplary phases of the present invention;

FIG. 2 is an exemplary block diagram illustrating one aspect of the portfolio management phase of the present invention;

FIG. 3 is an exemplary block diagram illustrating one aspect of the value planning phase of the present invention;

FIG. 4 is an exemplary block diagram illustrating one aspect of integrated governance in accordance with the present invention;

FIG. 5 is an exemplary block diagram illustrating one aspect of the project management aspect of the present invention;

FIG. 6 is an exemplary block diagram illustrating one aspect of post-implementation review in accordance with the present invention;

FIG. 7 is an exemplary block diagram illustrating a series of filters associated with the project management aspect of the present invention; and

FIG. 8 is an exemplary block diagram illustrating a various processing steps associated with one component of the customized project management aspect of the present invention.

### DETAILED DESCRIPTION

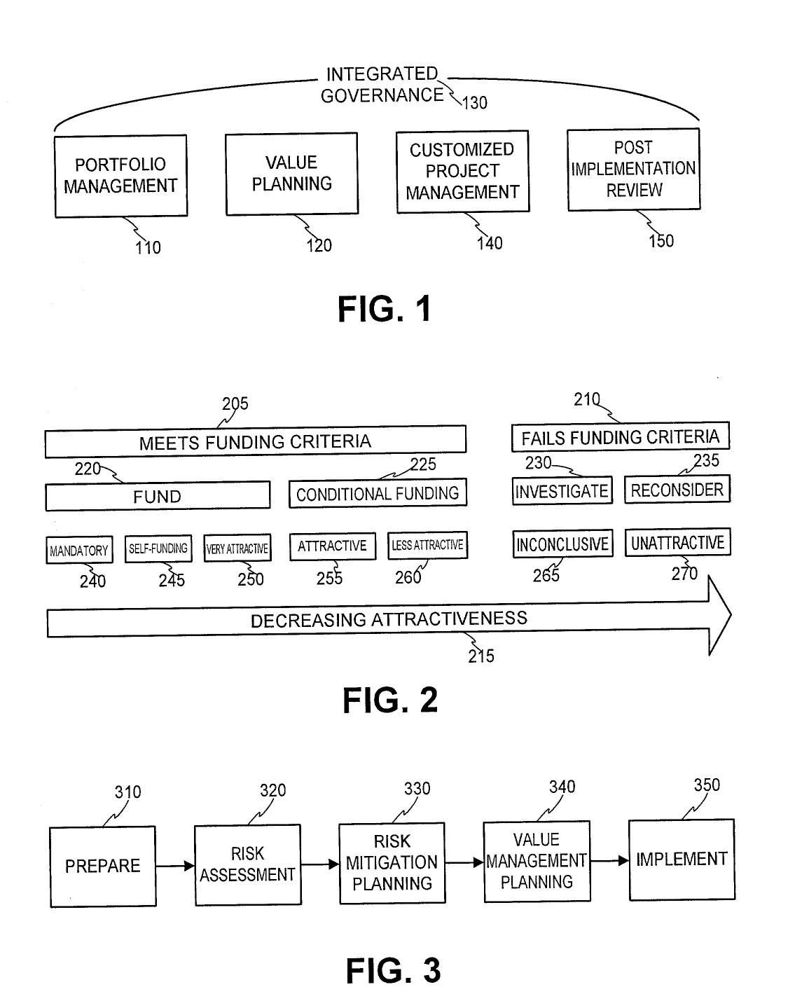

The present invention provides a project management system. The term “project” as used herein includes any system or method performed by an individual, entity, software, hardware, and/or the like for facilitating any task, investment, routine, goal, plan, procedure, analysis and/or the like. In an exemplary embodiment, as illustrated in FIG. 1, the project management system may generally include four separate phases or subsystems. These include portfolio management 110, value planning 120, customized project management 140, and post-implementation review 150. Various phases of the present invention may be further globally managed by an integrated governance subsystem or paradigm 130. While the invention is described with reference to four separate phases for ease of explanation, the invention also contemplates any number of phases, wherein the phases can be separate, interrelate, overlap or depend in any way on each other. Moreover, the exemplary embodiments may include manual input and analysis of data discussed herein and/or entry of the data into a computer system for computerized analysis of the data to produce results.

In an exemplary embodiment, portfolio management includes a series of filters that enables managers to create a more effective project portfolio, for example, by focusing a business unit's resources toward the highest yielding, highest growth projects while staying consistent with the business unit's overall operational strategies and objectives.

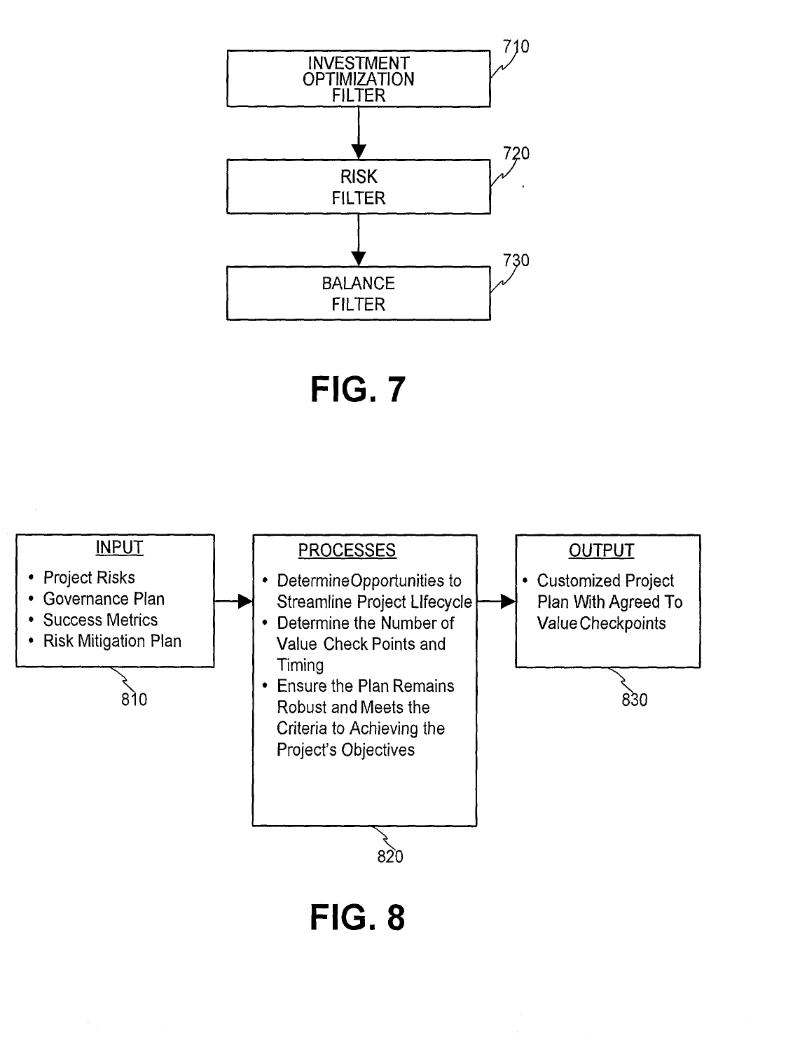

In accordance with one embodiment, portfolio management includes a series of three filters, as illustrated in FIG. 7. As used herein, “filter” includes any person, entity, hardware and/or software for reducing, selecting, analyzing, expanding, categorizing and/or the like various projects. While certain filters are described in a specific order, one skilled in the art will appreciate that any number of filters in any order and for any suitable purpose may be included in the present invention. The first is a project optimization filter 710, which enables managers to prioritize projects in terms of its attractiveness according to various tools and metrics. Next, a risk management filter 720 enables managers to analyze the level of risk associated with the project. Finally, the project is analyzed under a balance filter 730, which facilitates classification of the project according to its expected rate of return.

In accordance with an exemplary embodiment, project optimization filter 710 facilitates identification of project attractiveness according to a series of classification databases, as illustrated in FIG. 2. In accordance with one embodiment, seven databases are provided as follows: mandatory 240; self-funding 245, very attractive 250, attractive 255, less attractive 260, inconclusive 265, and unattractive 270. These databases are arranged from increasing to decreasing attractiveness and priority 215.

The databases are generally classified into two primary categories, “meets funding criteria” 205, and “fails funding criteria” 210. In accordance with a further aspect of the invention, primary categories 205 and 210 may be further defined by various sub-categories, or secondary categories. “Meets funding criteria” category 205 is further classified by funding category 220 and conditional funding category 225. “Fails funding criteria” category 210 is further classified by investigate category 230 and reconsider category 235.

In accordance with a further aspect of the present invention, the secondary categories are further classified by a tertiary set of categories or funding databases as described above. Fund category 220 is further classified by mandatory category 240, self-funding category 245, and very attractive category 250. Conditional funding category 225 is further classified by attractive category 255 and less attractive category 260. On the “fails funding criteria” 210 side, investigate category 230 is further classified by investigate category 265. Reconsider category 235 is further classified by unattractive category 270.

The categories may be defined by the various other subcategories and funding databases described above, in addition to various other metrics associated therewith. For example, the “meets funding criteria” category will typically be defined by criteria based upon various metrics and measures identified by the manager as being consistent with a business unit's objectives relating to growth, value, and budgetary considerations and tolerances. Similarly, the “fails funding criteria” category will be similarly predefined according to the criteria that fail the business unit's goals and tolerances.

For example, in the embodiment illustrated in FIG. 2, the “meets funding criteria” category includes all potential projects falling within the “fund” and “conditional funding” subcategories. Likewise, the “fund” and “conditional funding” categories are defined, at least in part, according to their associated funding databases. So, for example, all potential projects falling within the mandatory, self-funding, very attractive, attractive, or less attractive would be likely to qualify under the business unit's funding criteria and receive funding accordingly. In similar regard, projects falling within the various subcategories and funding databases associated with the “fails funding criteria” category would not likely receive funding by the manager business unit.

By way of further example, each funding database would be further defined by specific metrics and criteria. For example, the mandatory database 240 may be defined as those projects which are contractual, legal, or regulatory-base obligations, or the failure of which carries significant, immediate, and quantifiable loss of business. Such obligations may include banking regulations, SEC regulations, customer privacy issues and the like. Attractive database 255 may be defined as those projects that carry at least a positive 5-year net present value. Finally, unattractive database 270 may be defined as those projects having no net present value and no revenue growth potential.

Risk filter 720 facilitates identification of project risk. In accordance with an exemplary embodiment, risk identification is facilitated by the introduction of predefined categories based on prior projects and/or customers, either by the managers or third parties. The project is segmented based on the business unit's level of confidence in the outcome of the project. In this regard, project risk of all types may be identified and allocated across a particular business unit or across an entire enterprise.

In accordance with one embodiment, risk categories are provided as follows:

TABLE 1
Risk Filter

| Category | Risk Level |
|---|---|
| Infrastructure | Various |
| NPV | Low |
| Metrics | Medium |
| Discovery | High |

The infrastructure category includes projects in activities related to improvements in the business unit's infrastructure. Examples include Y2K compliance projects, upgrading billings systems, telephone systems updates, and the like. The NPV or net present value category includes projects with a measurable net present value. Other characteristics include those projects with a low uncertainty of outcome, established end-user markets, and a prior positive track record with similar projects or markets. Examples include on-line brokerage systems, membership banking systems, acquisition of customer accounts, and the like. The metrics category includes those projects with a difficult to measure net present value, but with other identifiable measurement metrics. Characteristics of these projects include a medium degree of outcome uncertainty, emerging end-user markets, and/or limited prior experience with the project or market. Examples of this type of project include merchant acquisition campaigns financial advisor acquisition expenses, credit card incentive programs, and the like. The discovery category includes projects with a non-measurable net present value and non-measurable or non-predictable metrics. Characteristics of these projects include high degrees of uncertainty with respect to outcome, unknown end-user markets, and inexperience with the project or market.

Balance filter 730 is a tool that segments projects into various categories on the basis of relative growth. In accordance with an exemplary embodiment, the categories may be identified as follows: efficiency, effectiveness, differentiation, and growth. Together with predefined return expectations, filter 730 may be implemented as follows:

TABLE 2

| Efficiency | Effectiveness |
|---|---|
| Return 2:1 | Return 3:1 |
| Differentiation | Growth |
| Return 10:1 | Return 20:1 |

Practitioners will appreciate that variation in the categories in expected yields may be defined in accordance with the present invention. For example, the categories and expected returns are highly variable and will be influenced by a business unit's portfolio as a function of its objectives and maturity.

The efficiency category includes compliance and control type projects. This includes projects in activities required to maintain a level of efficiency to optimize capacity, maintain business as usual, reduce costs, and to satisfy regulatory and compliance needs. More particularly, these projects include standardization, consolidation, decommissioning and centralization activities. Examples include projects in finance systems, accounting systems, human resource operations systems, management operations systems, control systems, security systems, regulatory and compliance systems, and safety systems.

The effectiveness category includes functional excellence type projects. This includes projects in activities and technology infrastructure that support process or service redesign systems with an emphasis on quality and reliability in order to improve customer satisfaction and reduce risk. Particularly, this category includes those projects which improve quality, service, reliability, or reduce or eliminate product defects, or improve system management capabilities. Examples include those projects that may focus on mail time improvements, risk modeling, workgroup computing, operations automation, and improvements in asset and inventory management.

The differentiation category includes product excellence type projects. These types of projects include those that distinguish a business unit's brands, products, and/or services by enhancing existing value propositions with added features, benefits, services, and options. Specifically, these projects leverage brand equity and loyalty, promote online marketing and selling, and promote product and service enhancements to increase revenue and market share. Examples include those projects that seek to expand external partners, integrate supply chains, facilitate e-procurement, and enhance interactive marketing, communications, recruiting, and learning.

The growth category includes portfolio excellence type projects. This includes projects in activities that are innovative and enable speedy response to market competition, particularly those that grow the customer base, introduce new revenue streams, and grow existing revenue streams. More particularly, these projects promote new businesses in attractive business markets and offer continuous innovation, seek enterprise integration, new business products and innovative product configurations. Additionally, these projects might be aimed at growing global networks, accelerating growth in market share an profits, and building a sustainable, long-term position in the marketplace. Examples includes new international products and services, unassisted business-to-business or business-to-customer transactions, and projects aimed at reducing development and delivery costs associated with products and services development.

In accordance with this aspect of the invention, various filters are designed to prompt further discussions and analyses between business units, finance departments, and other appropriate constituencies on the value of proposed projects and how the projects are related to overall growth objectives. Implementation of portfolio management aims to yield the highest possible return on projects, moves resources from low to high value projects, and highlights projects requiring increased risk management. This aspect of the present invention provides at least the following benefits: providing managers with a holistic picture of a project portfolio; provides a structured methodology for shifting funds from low-yield to high-yield projects; providing an economic model of portfolio return over time; and provides the ability to compare project spending against competitors in a standardized manner.

In accordance with a further exemplary aspect of the present invention, value planning is a formal methodology for executing projects to extract maximum value. In accordance with an exemplary embodiment, as illustrated in FIG. 3, value planning may include the following steps: preparation 310; risk assessment 320; risk mitigation planning 330; value management planning 340; and implementation 350.

Preparation step 310 generally includes aligning the project with a particular business unit's goals. Preparation activities may include assigning liaisons within various business units, including identification of points of contact and key personnel, and performing due diligence. Other activities may include identification of a particular business unit problem and suggestions for resolution of the problem involving a particular project. Market research may be used in support and planning could also include discussions relating to how resolution of the problem adds value to the business unit or related customers. Implementation issues may also be discussed at this stage.

In an exemplary embodiment, preparation stage 310 may be include distribution of a “pre-assessment survey,” identifying, among others, the following: the organization's readiness to deliver the proposed solution to the market place; customer and marketplace readiness for the solution being offered; potential effectiveness of project governance; ability of internal knowledge and resources to develop the proposed solution; probability of on-time project delivery; ability to meet various speed-to-market demands; complexity of the solution; innovation of the solution; and profitability of the solution. In an exemplary embodiment, these and other appropriate survey questions are put forth in a manner so that the survey recipient may respond by, for example, ranking the relative strengths or weakness of each issue presented. As with other procedures or steps in this invention, exemplary embodiments may include manual input and analysis of the data and/or entry into a computer system for computerized analysis of the data.

Preparation may be followed by a risk assessment step, illustrated as step 320. Risk assessment is performed to identify and gauge various risk factors associated with a project. This allows and facilitates the creation of a risk mitigation plan in the risk mitigation planning stage 330, discussed further below. In an exemplary embodiment, as illustrated in FIG. 3, risk assessment is initiated at the beginning of value planning, identified as step 120 in FIG. 1, such as immediately after the planning stage, identified as step 310 in FIG. 3.

In accordance with an exemplary embodiment, risk assessment includes scoring a series of risk related questions and statements. Based, at least in part, upon these responses, a model provides data identifying the aspects of the project which contain high levels of risk. The model may be based upon any suitable metric or algorithm to identify predetermined levels of risk associated with a project. Practitioners will appreciate that any suitable software and/or hardware may be used in accordance with this embodiment; however, in an exemplary embodiment, the model may be evaluated by commercially available software, for example, the “Value Planning” software by NorthPoint Software Services, Inc. located in Framingham, Mass. In additional embodiments, the software may be configured to compare the various identified risk aspects against a database of numerous other projects, successful and/or unsuccessful, to determine the relative risk of the proposed project. A customizable template may be used in accordance with the model, wherein the template may be modified in accordance with the particular project under consideration.

As described above, risk assessment factors are highly variable and customizable to a particular project. Preferably, risk assessment identifies and focuses on front-end critical success factors, gaps and risks. Some common risk factors may include: project/project value drivers; customer buying criteria for the associated products and services; the ability to execute and deliver promised value; the project's ease of use and ability to obtain endorsement of the product by market influences; vendor and partner ability to deliver value drivers; technology and service strategies for the product, and assessing the completeness of the management structure associated with the project.

In accordance with various other embodiments, a risk profile or “report card” may be generated which prioritizes various classifications of risk identified above, and benchmarks these risks against the industry best in class scores to offer a more accurate prediction of the project's success. The business unit may then use this report to facilitate risk mitigation planning, identified as step 330 in FIG. 3, discussed further below.

Additionally, in an exemplary embodiment, the business unit may wish to create a due diligence checklist to facilitate risk assessment. The checklist may seek to ensure the responsible business unit has thoroughly investigated the project and has accumulated all relevant and available documents to properly engage in risk assessment and value planning activities. This may include verifying the presence of the following, for example: a business plan; market data and competitive data including information about the size of the market; company revenue; product growth; market share; competitive position including competitive advantages and disadvantages; product information including marketing materials, hardware and software platforms supported, maintenance, discount structures, intellectual property issues including patents, copyrights, and trademarks; consumer data including customer survey results; management information including identification of management systems, budgets, and knowledge and experience necessary for proper support; external research including analysis or industry trends and various regulatory compliance issues; and outsource partner/vendor information, including knowledge, reputation, and experience of the outsource provider.

Risk mitigation planning, identified as step 330 if FIG. 3, includes the preparation of a risk mitigation plan. In a preferred embodiment, such planning may take place within a risk mitigation workshop included of various key personnel associated with the project. In accordance with the invention, risk mitigation planning includes the creation of risk mitigation action steps that will be taken to minimize at least some of those risks identified as high in the risk assessment step 320, discussed above or other risks identified by project participants.

The creation of various risk mitigation steps will be highly variable depending upon the specific nature of the project. In general, such mitigation steps may include assigning accountability factors and success criteria to various team members, in addition to defining completion targets for various project implementation steps, and identifying key metrics to monitor the successful mitigation of various risk factors. Some common, more specific, risk mitigation action items may include the following: minimizing team turnover in critical slots, such as, for example, by offering incentives or bonuses at project completion; minimize fragmented governance by implementing global governance strategy, such as, for example, implementing integrated governance methodologies identified as step 130 in FIG. 1; improving focus on customer service issues by, for example, implementing surveys shortly after launch, and throughout the project life cycle.

In accordance with an exemplary embodiment, the information contained in the risk mitigation plan may be used to facilitate value management planning, identified as step 340 in FIG. 3. In accordance with the present invention, a value management plan (“VMP”) may be created during value management planning 340. A VMP may include, for example, a collection of documents which serve as a tool for project team members to identify various categories of project risk, and the degree of risk associated with each category, the actions being taken to mitigate the risk, a customized project path and success metrics identified for the project. Additionally, the VMP may also include activities associated with the post-implementation review step, such as illustrated by step 150 in FIG. 1, and discussed in further detail below. The VMP may be revised to keep pace with various changing dynamics over the lifetime of the project.

In various exemplary embodiments, the VMP contains the following documents: a business model; a project management plan; a governance framework; identification of customized project management path and value checkpoints; and success metrics.

In accordance with an exemplary embodiment of the present invention, the business model is more narrowly focused than a typical business plan, which generally encompasses all factors related to running and sustaining a business. A business model may be more narrowly focused on, for example, three goals: (1) plans and methodologies that clearly establish a “model” of how the project will deliver the promised technology, products, and/or services to market; (2) the establishment of the alignment relationship between the product, channel, and sales teams to out compete the competition; and (3) demonstrates precisely how the project will generate revenue. The business model may also address other critical factors such as channels of distribution by market segment, market penetration plans, product positioning, pricing plans, and partnerships descriptions. In an exemplary embodiment, the business model also demonstrates proof to the managers that the requested funds will yield the targeted return, such as, for example, by explanation of volume assumptions, capture ratios, etc., and how these factors are reasonable in accordance with industry expectations or based on credible justification deltas.

The project management plan, in one embodiment, includes a detailed project plan identifying substantially all steps and tasks required for full development of the project in the context of an overall project timeline. Such information may include identification of which parties are responsible for which set of tasks as well as setting forth the goals and/or deadlines for completion of those tasks.

The governance framework includes, for example, a governance structure, roles and responsibilities, success metrics, performance management and engagement. For further description of these systems and methodologies, see the discussion of integrated governance, illustrated in FIG. 1 as step 130, discussed further below.

The customized project management path and value checkpoints are described in more detail in reference to customized project management, illustrated as step 140 in FIG. 1.

In accordance with the value management plan, success metrics may include documents establishing end-to-end metrics that focus on overall process and project outcomes. In accordance with an exemplary embodiment of the present invention, there are at least two types of success metrics documents: a balanced scorecard; and a value assurance template.

A balanced scorecard includes a high-level document that provides foundation for performance and incentive management. Success metrics are further identified in accordance with discussions involving the integrated governance step, illustrated as step 130 in FIG. 1, below. An exemplary scorecard should include metrics defining financials, growth and/or improvement objectives, satisfaction assessment from customers, third party evaluations and/or perceptions, and control commitment (e.g., audit and regulatory).

A value assurance template is used, for example, to manage metric performance on an ongoing basis and is used to conduct the value assurance assessment as part of the post-implementation review activities. The template lists key success measures for the project, defines the existing/baseline metric results measured from initiation to completion, and identifies who is responsible for providing metric results. In addition to success measurements referenced in the balanced scorecard, the template may include all measures referenced in all other reports associated with the project.

Implementation step 350 implements many, if not most, of the various metrics and measures identified with respect to value planning. In various exemplary embodiments, implementation includes various value checkpoints to ensure compliance with various predefined success metrics, managing project progress, managing various project issues as they arise, track and report project progress, manage change (both internal and external), and close the planning loop with post-implementation review methodologies discussed in further detail below.

In accordance with this aspect of the present invention, value planning provides an early warning mechanism for projects that are likely to sub-perform, allowing quick terminations and redirection of project funds. Additionally, value planning provides early identification of “game changer” opportunities, allowing resources to be redirected to high-potential projects. Value planning also focuses managers on the value drivers, metrics and practices that will maximize the return on project.

In an exemplary embodiment, with momentary reference back to FIG. 1, integrated governance 130 includes a holistic framework for managing a project based on complexity, potential business impact and risk scores.

Integrated governance, in accordance with an exemplary embodiment, may be executed as a governance framework. The holistic approach however may not be standard solution; rather, the application may be influenced by various characteristics of the project and should be considered accordingly.

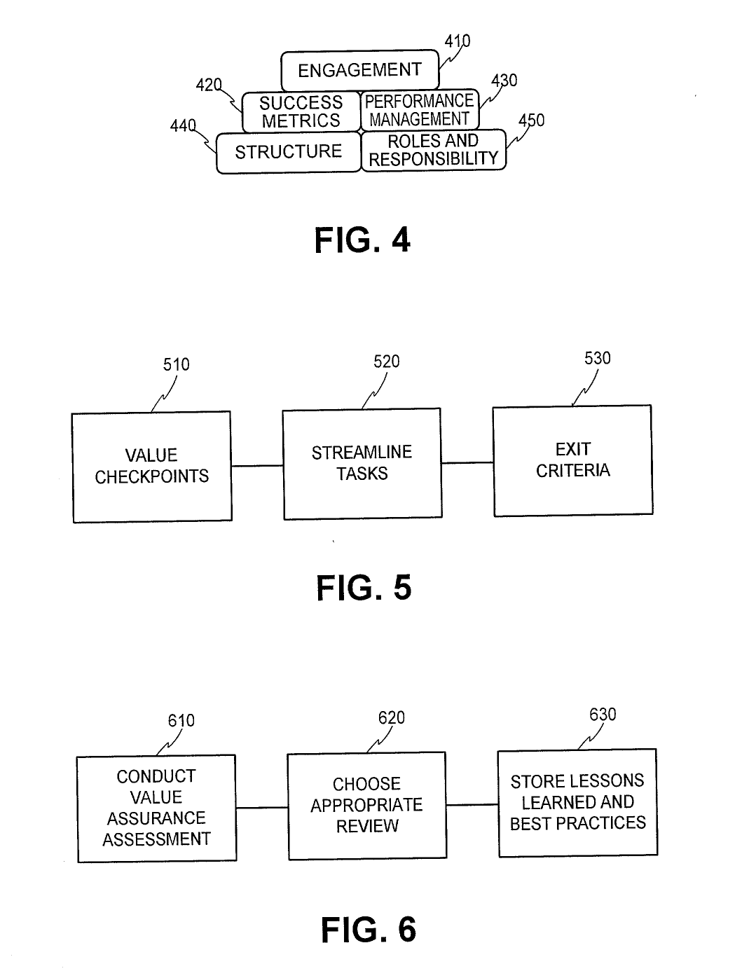

As illustrated in FIG. 4, an exemplary governance framework includes a pyramid of interrelated components with various activities engaged in by appropriate personnel, for example, project managers.

At its foundation, integrated governance includes identifying the governance structure and various roles and responsibilities of persons associated with the project. Within the structure component 440, a project manager or other responsible person determines the level of governance desired for the project in terms of complexity and risk. More complex or riskier projects may require more supervisory personnel and oversight as compared to smaller projects comprising less complexity and risk. In the latter case, the project manager may determine relative minor staffing and oversight is appropriate. The structure component 440 streamlines the governance process by realizing that governance is not necessarily a standard solution and may be highly variable according to the particular needs of the project. Governance activities within the structure component 440 may also include, for example, structuring various levels of governance tiers or layers according to predefined metrics.

In an exemplary embodiment, a governing structure may be set forth as including an executive committee, an operating committee, and a project management core team. The executive committee may be responsible for the overall success of the project and achievement of predetermined business objectives. The operating committee may be responsible for successful integration and delivery of the initiative to product the desired results. The project management core team may be responsible for the day-to-day execution of the project. The chair of the executive committee is known as a business sponsor. The chair of the operating committee is known as a product manager. The chair of the project management core team is known as a project integrator.

Participants in the executive committee may include, for example, the following: business sponsor, technology sponsor, service delivery sponsor, customer experience advocate, product manager, project integrator, key internal executives as required (e.g., advertising, finance, etc.), and external partner executives, as appropriate. Participants in the operating committee may include, for example, the following: product manager, new product development manager, project integrator, customer servicing leader, technologies relationship leader(s), key internal leaders as required, vendor and partnership coordinator, and external partner(s) as appropriate. Participants in the project management core team may include, for example, the following: project integrator, product marketing, product configuration, customer servicing single point of contact (SPOC), technologies SPOC, other internal partner SPOCs as required, and external partner(s) SPOCs as appropriate.

Once the appropriate governance structure is determined for the project team, the next component determines the roles and responsibilities of each team member 450. These may be assigned according to any predetermined metric. In an exemplary embodiment, a single point of contact will be assigned accountability across multiple functions thereby further integrating the governance process.

Some exemplary roles and responsibilities for some of the committee chairs are as follows. The role of product manager is to be a SPOC for the end-to-end initiative, with overall accountability for the P&Ls throughout the product's lifecycle. Principle responsibilities include value proposition, product planning, marketing, and advertising; product and project success metrics; and “close the loop” backend review to ensure performance according to expectation, and to collect and share lessons learned for continuous improvement. The role of the project integrator is to integrate multiple business, technology, and service areas within the business unit as well as multiple external vendors and partners. Principle responsibilities include integrating plans across different business units and vendors; communicating and changing management; advising the executive on delivery staging and resolution of cross-organizational issues; and coordinating with internal review boards.

The role and responsibilities for an exemplary committee participant, in this case, a customer experience advocate, is provided below. The customer experience advocate serves as a single point of integration for ensuring an exceptional end-to-end customer experience, including initial touches, acquisition processing, transaction processing, and integrated servicing through multiple channels. Principle responsibilities include upholding customer buying criteria and ensuring delivery of the seamless end-to-end customer experience; developing servicing strategies and solutions; and developing and tracking customer care success metrics and client satisfaction goals.

Roles and responsibilities in accordance with this aspect of the invention, may further be set forth in a document, and/or a matrix, detailing the roles desired for successful completion of the project and specifies individuals responsible for fulfilling these roles. For example, a roles and responsibilities matrix may include four levels of responsibility: primary; contributor; approver; and reviewer. A primary role involves producing, preparing, or coordinating an activity or deliverable. A contributor role is given to persons whose agreement is vital to the project either because they are affected by the project or contribute to its success. An approver authorizes the start of a next stage of the project, and may override disagreement from the parties. A reviewer has the role of commenting, agreeing, or disagreeing on various aspects of the project. The matrix may be used in classifying the various key personnel identified above.

Accordingly, the structure component 440 and the roles and responsibilities component 450 establishes a foundation for the project, facilitates the formation of teams with clear understandings of sponsorship, cross-functional accountability, and high levels of inclusion, and fosters a high degree of readiness to execute the initiative.

In an exemplary embodiment, after establishing the foundation, integrated governance looks to establishing criteria for success through the success metrics component 420 and performance management component 430. Within the success metrics component 420, the project manager seeks to create a “balance scorecard” of pre- and post-launch metrics for innovation, process, customers, and shareholders.

A balance scorecard, in accordance with a further exemplary embodiment, may be constructed as provided below:

TABLE 3

| Shareholder | Innovation |
|---|---|
| Project yield | high-level team KEP |
| Time to positive | (knowledge, |
| cash flow | experience, |
| increase revenue, | performance) |
| pre-tax income, | increased % of |
| cash flow, etc. | revenue from new |
| improved gross and | products |
| net profit margin | first to market |
| improved time to | offerings |
| profitability | patents applied for or |
| reduce costs | issued |
| Customer | Process |
| customer | on time/on budget/ |
| satisfaction | on scope/on value |
| partner satisfaction | use of new, |
| (internal/external) | streamlines or |
| improved gross | simplified product |
| customer reported | development |
| defects | approaches |
| reduce turnover | improved delivery of |
| (returns or | cycle times and |
| cancellations) | overall time-to- |
| | market |

The performance management 430 component seeks to improve performance by creating incentive and reward strategies that foster long-term achievement of project objectives, while also recognizing the level of risk undertaken. Performance management is an on-going process that binds the team together in delivering customer benefits and provides clarity to the team and to individuals, and promotes and rewards aligned behaviors that convert risk into value. Good performance management practices include, for example: focusing on how well the team and individuals are carrying performing; ensuring that team members are aware that they should focus on more than their own individual performance; promoting effective cross-functional teaming; and promoting end-to-end accountability across entire enterprises. Together, components 420 and 430 establish criteria for success wherein team members are aligned on a common fact-base for measuring business results, and for rewards that drives team behaviors and joint accountability.

In an exemplary embodiment, after building upon the proper foundation and establishing the proper criteria for success, integrated governance establishes governance agendas and protocols that execute, monitor, and measure by setting forth expectations for accountability and results within engagement component 410.

An agenda setting forth expectations and accountability may stress that execution depends upon a governance agenda and protocols that insist on, for example, the following: sufficient and consistent executive partnership; effective teaming, issue resolution, and decision making practices; and a “keep your eye on the prize” approach that ensures the delivered solution supports the end-to-end customer perspective. Principles of engagement include, for example: employing a “venture capital mindset” by demanding achievement of the stated business objectives; “keeping the team honest” by encouraging communication of disappointments; and to be accountable and insist upon active participation by all stakeholders.

In accordance with this aspect of the present invention, integrated governance facilitates the creation of integrated customer solutions that deliver superior product quality and servicing and cross-functional business focuses that seek cooperation and increased speed and value. Integrated governance further facilitates clear consensus on accountabilities that promotes speed in decision-making and execution, and effective oversight of complex, cross-organizational and/or high risk projects.

In accordance with the present invention, with momentary reference back to FIG. 1, customized project management 140 includes a customized, tactical approach to managing risk and maintaining product value during the execution of a project by introducing various degrees of project management rigor depending upon unique project needs, as well as collapsing and stripping out non-value add tasks.

Customized project management (“CPM”) utilizes a set of criteria at specified points in the project life cycle to determine if project performance is on track to receive additional funding and continue to the next point in the lifecycle. These specified points, called “value checkpoints,” focus on identifying if the project can meet the value proposition and business case deliverables. At these checkpoints, decisions are made to stop the project or continue the project and mitigate risk to ensure success. In accordance with an exemplary embodiment of the present invention, CPM includes defining the project management path and managing value checkpoints.

In an exemplary embodiment, the project management path is defined using predetermined input, output, and processing steps, as is illustrated in FIG. 8. Input step 810 includes identification of various governance elements developed in accordance with a desired project. These may include, for example, identification of project risks, and success metrics, and development of a governance plan, and a risk mitigation plan.

These various inputs are then processed according to processing step 820. Processing step 820 utilizes the input information to determine, for example, sufficient opportunities to streamline the project lifecycle, the appropriate number and type of value checkpoints, and appropriate stages for conducting the value checkpoints within the project lifecycle. In addition, processing step 820 utilizes the input information to verify that the plan remains robust and meets the criteria to achieve the project's objectives. Processing of the various information yields a customized output in output step 830. In accordance with this step, a customized project plan is created with appropriately tailored value checkpoints.

In an exemplary embodiment, after defining the customized project path and associated value checkpoints, the customized project management step seeks to manage the value checkpoints. In accordance with the present invention, value checkpoints include a small but powerful set of metrics and regulators that gauge the readiness to invest and move through the various stages of the lifecycle. The value checkpoints include a series of gates that allow a project to advance, subject it to higher levels of scrutiny and/or mitigation activities, or terminate the project. Advancement through the checkpoints includes achieving specific entry and exit criteria and meeting relevant business metrics (i.e., risk, value, and knowledge) in order, for example, to obtain next-round funding or termination.

In an exemplary embodiment, the value checkpoints are managed as illustrated in FIG. 5. Various inputs are identified in value checkpoint step 510. The input includes a risk index which defines the risk of the project, project duration which identifies the timeline of the project, complexity which refers to the challenges or level of complexity associated with the project, and the ability to meet these challenges based on the knowledge, experience, and performance expectations of the project team. Calculation of the risk index, in one embodiment, may be based on known industry risk and success factors, and then conducting a benchmark comparison of the proposed project thereto. The comparison may then generate a risk score based on how well the proposed projects compares to these provided risk and/or success factors.

The value check inputs are then used to streamline various project tasks in association with step 520. In an exemplary embodiment, various aspects of the project may be combined, including, for example: project reports; technical and business conceptual overview; and new product servicing and technology deliverables. To further these streamlining efforts, certain tasks or duties may be limited or scaled-down including, for example, the involvement of review boards and their associated activities. Certain other tasks may also be eliminated or reduced, including any documentation deliverables determined not to add value.

In an exemplary embodiment, an exit criteria is established as illustrated in step 530. In general, the exit criteria may consist of, for example, three gateways: the fail or stop gateway; the fast fail or risk mitigation gateway; and the continuation gateway. The fail or stop gateway is activated when the project is not on track with the predefined value proposition and/or when unforeseen and undesirable risks develop. In this case, the project may be terminated. The fast fail or risk mitigation gate is enacted when there appear risks that may jeopardize the viability of the project, but are determined manageable with the intervention of a risk mitigation plan. In this case, the various steps associated with the risk mitigation plan will be enacted in attempting to save the plan. If risk mitigation fails, the plan is aborted as described above. If mitigation is successful, the plan proceeds to the continuation gateway as described below. In accordance with a further aspect of this embodiment, mitigation and failure determinations should be made quickly so as to minimize project disruptions and/or loss. The continuation gateway is utilized where the project is on track with a solid value plan and controllable risks, and/or when the plan has been successfully mitigated as described above.

In accordance with this aspect of the invention, various measures may be enacted to track project performance and success. The measures are taken at a sufficient number of checkpoints throughout the project lifecycle to mitigate risks and identify those projects which should be stopped. Accordingly, greater efficiencies are achieved as project failures are identified and stopped where associated funds are then diverted to other more profitable projects.

Post-implementation review facilitates verification of value propositions and business case projections and verification that original initiatives are actually achieved. In accordance with an exemplary embodiment, post-implementation review includes conducting value assurance (“VA”); and leveraging organizational experience (“LOE”) activities.

An exemplary post-implementation review process is illustrated with reference to FIG. 6. In accordance with an exemplary embodiment, the first step in post-implementation review is to conduct a value assurance assessment, as identified in step 610. Within this step, a project manager may update the project by inputting the project results and then comparing those results with the originally defined project estimates. This data may then be placed into a common data repository. In an exemplary embodiment, this step is conducted within a month of the project launch and/or after the project is reported at profitability.

In an exemplary embodiment, the next step in this process is to conduct an appropriate post-implementation review as identified in step 620. In this step, a meeting is typically conducted among all team participants. The original project estimates may be compared, including value expectation and risk estimates, with final project outcomes.

Relative successes and failures according to the numerous predefined project metrics are discussed and may be reduced to writing. The successes and failures should then lead to a further discussion about the lessons learned from the project, such as the necessity of early inclusion of all business partners early in the project life-cycle, establishing project management principles with vendors, and identifying the required subset of skills for successful implementation of the project and then ensuring that the project is staffed with individuals possessing those skill sets accordingly. These lessons are then also preferably reduced to writing, and, more preferably, formalized into a “lessons learned” document. In an exemplary embodiment, the lessons learned documents are then preserved in a lessons learned information repository. This repository is preferably indexed according to various suitable metrics, including project size, cost, complexity, participants, and business unit origination.

Post-implementation review provides a closed-loop process helping to verify that each project, and the portfolio as a whole, has delivered according to expectations and that derived learnings inform future project and execution strategies. A rigorous closed-loop project management system facilitates, for example: making better future project decisions based upon real data from earlier experiences; making real-time adjustments to risk models based on actual project performance; having more first-time successes by formally harnessing and leveraging organizational experience; and increasing manager accountability for project performance with the ability to compare multiple years actuals with original projections.

The system may be implemented in hardware and/or software, so the system may include a host server or other computing systems including a processor for processing digital data, a memory coupled to said processor for storing digital data, an input digitizer coupled to the processor for inputting digital data, an application program stored in said memory and accessible by said processor for directing processing of digital data by said processor, a display coupled to the processor and memory for displaying information derived from digital data processed by said processor and a plurality of databases, said databases including client data, merchant data, financial institution data and/or like data that could be used in association with the present invention. As those skilled in the art will appreciate, user computer will typically include an operating system (e.g., Windows NT, 95/98/2000, Linux, Solaris, etc.) as well as various conventional support software and drivers typically associated with computers. User computer can be in a home or business environment with access to a network. In an exemplary embodiment, access is through the Internet through a commercially-available web-browser software package.

Communication between the parties to the transaction and the system of the present invention is accomplished through any suitable communication means, such as, for example, a telephone network, Intranet, Internet, point of interaction device (point of sale device, personal digital assistant, cellular phone, kiosk, etc.), online communications, off-line communications, wireless communications, and/or the like. One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

The databases may be any type of database, such as relational, hierarchical, object-oriented, and/or the like. Common database products that may be used to implement the databases include DB2 by IBM (White Plains, N.Y.), any of the database products available from Oracle Corporation (Redwood Shores, Calif.), Microsoft Access by Microsoft Corporation (Redmond, Wash.), or any other database product. Database may be organized in any suitable manner, including as data tables or lookup tables. Association of certain data may be accomplished through any data association technique known and practiced in the art. For example, the association may be accomplished either manually or automatically. Automatic association techniques may include, for example, a database search, a database merge, GREP, AGREP, SQL, and/or the like. The association step may be accomplished by a database merge function, for example, using a “key field” in each of the manufacturer and retailer data tables. A “key field” partitions the database according to the high-level class of objects defined by the key field. For example, a certain class may be designated as a key field in both the first data table and the second data table, and the two data tables may then be merged on the basis of the class data in the key field. In this embodiment, the data corresponding to the key field in each of the merged data tables is preferably the same. However, data tables having similar, though not identical, data in the key fields may also be merged by using AGREP, for example.

The computer may provide a suitable website or other Internet-based graphical user interface which is accessible by users. In one embodiment, the Internet Information Server, Microsoft Transaction Server, and Microsoft SQL Server, are used in conjunction with the Microsoft operating system, Microsoft NT web server software, a Microsoft SQL database system, and a Microsoft Commerce Server. Additionally, components such as Access Sequel Server, Oracle, MySQL, Intervase, etc., may be used to provide an ADO-compliant database management system. The term “webpage” as it is used herein is not meant to limit the type of documents and applications that might be used to interact with the user. For example, a typical website might include, in addition to standard HTML documents, various forms, Java applets, Javascript, active server pages (ASP), common gateway interface scripts (CGI), extensible markup language (XML), dynamic HTML, cascading style sheets (CSS), helper applications, plug-ins, and the like.

The present invention may be described herein in terms of functional block components, screen shots, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention could be used to detect or prevent security issues with a client-side scripting language, such as JavaScript, VBScript or the like. For a basic introduction of cryptography and network security, the following may be helpful references: (1) “Applied Cryptography: Protocols, Algorithms, And Source Code In C,” by Bruce Schneier, published by John Wiley & Sons (second edition, 1996); (2) “Java Cryptography” by Jonathan Knudson, published by O'Reilly & Associates (1998); (3) “Cryptography & Network Security: Principles & Practice” by William Stalling, published by Prentice Hall; all of which are hereby incorporated by reference.

It will be appreciated, that many applications of the present invention could be formulated. One skilled in the art will appreciate that the network may include any system for exchanging data or transacting business, such as the Internet, an intranet, an extranet, WAN, LAN, satellite communications, and/or the like. It is noted that the network may be implemented as other types of networks, such as an interactive television (ITV) network. The users may interact with the system via any input device such as a keyboard, mouse, kiosk, personal digital assistant, handheld computer (e.g., Palm Pilot®), cellular phone and/or the like. Similarly, the invention could be used in conjunction with any type of personal computer, network computer, workstation, minicomputer, mainframe, or the like running any operating system such as any version of Windows, Windows NT, Windows2000, Windows 98, Windows 95, MacOS, OS/2, BeOS, Linux, UNIX, Solaris or the like. Moreover, although the invention is frequently described herein as being implemented with TCP/IP communications protocols, it will be readily understood that the invention could also be implemented using IPX, Appletalk, IP-6, NetBIOS, OSI or any number of existing or future protocols. Moreover, the system contemplates the use, sale or distribution of any goods, services or information over any network having similar functionality described herein.

The computing units may be connected with each other via a data communication network. The network may be a public network and assumed to be insecure and open to eavesdroppers. In the illustrated implementation, the network may be embodied as the internet. In this context, the computers may or may not be connected to the internet at all times. For instance, the customer computer may employ a modem to occasionally connect to the internet, whereas the bank computing center might maintain a permanent connection to the internet. Specific information related to the protocols, standards, and application software utilized in connection with the Internet may not be discussed herein. For further information regarding such details, see, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997). LOSHIN, TCP/IP CLEARLY EXPLAINED (1997). All of these texts are hereby incorporated by reference.

The systems may be suitably coupled to network via data links. A variety of conventional communications media and protocols may be used for data links. Such as, for example, a connection to an Internet Service Provider (ISP) over the local loop as is typically used in connection with standard modem communication, cable modem, Dish networks, ISDN, Digital Subscriber Line (DSL), or various wireless communication methods. Merchant system might also reside within a local area network (LAN) which interfaces to network via a leased line (T1, D3, etc.). Such communication methods are well known in the art, and are covered in a variety of standard texts. See, e.g., GILBERT HELD, UNDERSTANDING DATA COMMUNICATIONS (1996), hereby incorporated by reference.

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical electronic transaction system.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention is described herein with reference to screen shots, block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

In the foregoing specification, the invention has been described with reference to specific embodiments. However, it will be appreciated that various modifications and changes can be made without departing from the scope of the present invention. The specification and figures are to be regarded in an illustrative manner, rather than a restrictive one, and all such modifications are intended to be included within the scope of present invention. For example, the steps recited in any of the method or process claims may be executed in any order and are not limited to the order presented.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “includes”, “comprising”, or any other variation thereof, are intended to cover a non-exclusive inclusion, such that a process, method, article, or apparatus that includes a list of elements does not include only those elements but may include other elements not expressly listed or inherent to such process, method, article, or apparatus. Further, no element described herein is required for the practice of the invention unless expressly described as “essential” or “critical”.

We claim:

1. A project management system including:
a portfolio management subsystem configured to facilitate prioritization of a project in relation to other projects within a portfolio according to predefined objectives;
a value planning subsystem configured to facilitate assessment of project risk relative to comparable industry data;
a customized project management subsystem configured to facilitate applying varying levels of management oversight according to project complexity and risk factors; and
a post-implementation review subsystem configured to facilitate storing project data including original project expectation data and post-project performance data, wherein both sets of data are subject to comparative analysis to facilitate institutional learning concerning project investment and associated management processes.

2. The project management system of claim 1 further comprising:
an integrated governance subsystem wherein the portfolio management subsystem, value planning subsystem, customized project management subsystem, and post-implementation review subsystem are subject to a holistic governance framework based upon previously identified project complexity analyses, value analyses, and risk analyses.

3. The integrated governance subsystem of claim 2 further comprising a governance framework identifying the governance structure of project team members, roles and responsibilities of the project team members, and success metrics for the project.

4. The portfolio management subsystem of claim 1 further comprising at least three filters wherein:
a first filter is configured to prioritize projects based upon predefined funding criteria;
a second filter is configured to categorize the relative risk of the project based upon predefined risk filter categories; and
a third filter is configured to categorize the project into predefined investment categories based on relative expected growth.

5. The value planning subsystem of claim 1 further comprising:
a risk identification subsystem where at least some risk factors are identified at project inception;
a risk assessment subsystem where the risk factors are assessed in relation to predefined objectives; and
a risk mitigation subsystem where risk mitigation plans are created based, at least in part, upon the risk factors identified by the risk mitigation subsystem.

6. The value planning subsystem of claim 5 further comprising:
a value management subsystem configured to identify successful management strategies for the project based upon predefined value-based success criteria and previously identified risk factors and mitigation plans; and
an implementation subsystem configured to monitor risk factors throughout the lifecycle of the project to ensure that the project is meeting predefined value-based success criteria.

7. The customized project management subsystem of claim 1 further configured to define a project management path based upon input data including project risk data, success metric data, governance plan data, and a risk mitigation plan data, wherein said customized project management path facilitates the application to a customized management solution based on the unique complexity and risk factors of the project.

8. The customized project management subsystem of claim 1 wherein customized project management processes include the application of at least one value checkpoint during the lifecycle of the project, wherein the value checkpoint include at least a termination gate and a continuation gate and wherein activation of the checkpoint gates is based on meeting relevant success criteria and business metrics.

9. The post-implementation review subsystem of claim 1 wherein data generated from said comparative analyses is stored into a common data repository and wherein said repository is indexed to guide future institutional project investments and associated management processes.

10. A project management method including:
prioritizing a project in relation to other projects within a portfolio according to predefined objectives;
assessing project risk relative to comparable industry data;
applying varying levels of management oversight according to project complexity and risk factors; and
storing project data including original project expectation data and post-project performance data, wherein both sets of data are subject to comparative analysis to facilitate institutional learning concerning project investment and associated management processes.
